(19) United States
(12) Patent Application Publication
(10) Pub. No.: US 2023/0314077 A1
(43) Pub. Date: Oct. 5, 2023

(54) Continuously Charged Electric Arc Furnace System

(71) Applicant: Ami International Sapi De C.V, Monterrey (MX)

(72) Inventor: Mariana Viale, Monterrey (MX)

(21) Appl. No.: 18/120,140

(22) Filed: Mar. 10, 2023

Related U.S. Application Data
(60) Provisional application No. 63/318,518, filed on Mar. 10, 2022.

(51) Int. Cl. F27B 3/28; F27B 3/08; F27B 3/18; G06T 7/00; G06T 7/20; G06T 7/50

(52) U.S. Cl. CPC F27B 3/28; F27B 3/085; F27B 3/18; G06T 7/0004; G06T 7/20; G06T 7/50; G06T 2207/10024; G06T 2207/30136

(57) ABSTRACT

Methods and systems for determining a feed rate (unit mass/unit time) of metallic scrap material in real time being charged to an electric arc furnace (EAF) is provided, in which the methods and systems determine the speed of the metallic scrap material in real time and the volume of the metallic scrap material in real time. The methods and systems also classify the metallic scrap material via a machine learning model based on digital images of the metallic scrap material and assign a density to the metallic scrap material. The feed rate is determined based on the speed and volume of the metallic scrap material and the assigned density.

### CROSS-REFERENCE TO RELATED APPLICATIONS

This application claims priority under 35 U.S.C. §119 to U.S. Pat. Application No. 63/318,518 filed Mar. 10, 2022, which is expressly incorporated by reference herein in its entirety.

### TECHNICAL FIELD

Embodiments of the presently-disclosed invention relate generally to methods and systems of determining a feed rate (unit mass/unit time) of metallic scrap material, for example in real time, being charged to an EAF via a conveyor (or other transportation device), as well as methods and systems related to operating an EAF system based in part on the determined feed rate of the metallic scrap material.

### BACKGROUND

The traditional method of steel production is based on a blast furnace (BOF) route in which iron ore is reduced and molten in a blast furnace using coke before refining in BOF converter. The coke burns and produces energy and the iron ore is reduced due to its reactions with carbon and carbon monoxide. However, in the last few years the Electric Arc Furnace (EAF) steel making process is rapidly gaining interest over the BOF technology worldwide.

Among the advantages of the EAF process, next to lower emissions, flexibility is an argument on behalf of EAFs. This process is extremely flexible compared with the BOF route, which cannot be turned on and off at will in accordance with current market situation. The tendency towards more advanced, flexible, and cleaner processes calls for technology which can be quickly implemented and adapted to the specific needs of each steel producer.

In addition, the Consteel® technology, which is a unique steel-making process developed that continuously pre-heats and feeds the metallic charge (scrap metal, pig iron, hot briquetted iron, etc.) into an EAF while simultaneously controlling gaseous emissions. In particular, the Consteel® technology uses a conveyor to charge the raw materials (e.g., metallic scrap) into the EAF. The charge is loaded from a scrap yard or from a railcar into the charge conveyor and pre-heated by process off-gas as it is continuously fed into the EAF, where it is melted by immersion in liquid steel. In this regard, the EAF operates in constant flat bath conditions, which is a key advantage over conventional batch processes.

Although the Consteel® systems have environmental and energy consumption benefits, there are some drawbacks that prevent them to be more widely accepted. The main issue besides the cost of the installation, is the tapping weight estimation. Usually the Consteel® systems rely on load cells at the EAF base to estimate the EAF weight. These sensors are difficult to maintain and suffer from altered readings every time the EAF tilts.

Accordingly, there remains a need in the continuously fed EAF art for a non-contact system to determine the metallic scrap material being charged into the EAF, such as in real time, without the need for one or more of the use of load cells, crane feed data regarding the deposition of metallic scrap material onto the conveyor, and/or operator inputs.

### SUMMARY OF INVENTION

Certain embodiments according to the invention provide a method of determining a scrap feed rate, such as in real time, of an electric arc furnace (EAF) having a conveyer transporting metallic scrap material into the EAF. The method may include the following steps: (i) obtaining a first plurality of red-green-blue (RGB) digital images of a first portion of the metallic scrap material being transported by the conveyer; (ii) determining a first speed of the first portion of the metallic scrap material in a computer processor by comparing a first frame and a second frame of the plurality of RGB digital images of the first portion of the metallic scrap material being transported by the conveyer; (iii) generating a first depth image via camera stereo vision of the first portion of the metallic scrap material in the computer processor, wherein one or more pixels of the first depth image are correlated to 3D coordinates of the first portion of the metallic scrap material in the computer processor; (iv) determining a first volume of the first portion of the metallic scrap material in the computer processer based on at least a portion of the 3D coordinates of the first portion of the metallic scrap material; (v) identifying a first classification of the first portion of metallic scrap material from a group of known metallic scrap materials based on at least a portion of a first RGB image via a machine learning model in the computer processor, and assigning a first density to the first portion of scrap material; and (vi) determining the scrap feed rate associated with the first portion of the metallic scrap material being transported by the conveyor based on (a) the first volume of the first portion of the metallic scrap material, (b) the assigned first density, and (c) the first speed of the first portion of the metallic scrap material.

In another aspect, certain embodiments according to the invention provide a method of operating an EAF. The method may comprise determining a real time scrap feed rate of metallic scrap material being transported into the EAF via a conveyor in real time, such as described and disclosed herein. The method may also comprise comparing the real time scrap feed rate with an operating state of the EAF in a computer processor. Additionally, the method may comprise a step of modifying a conveyor speed of the conveyor transporting the metallic scrap material into the EAF, modifying an electric current flow to electrodes in the EAF, or both, such as in real time.

In another aspect, certain embodiments according to the invention provide a system for determining a scrap feed rate of an EAF having a conveyer transporting metallic scrap material into the EAF. The system may comprise a sensor fusion module including two monochrome cameras configured to provide stereo vision, a RGB camera, an infrared spectrum projector, and a first computer processor in operative communication with the two monochrome cameras, the RGB camera, and the infrared spectrum projector. The first computer processor, for example, may be configured to (a) determine the speed of the metallic scrap material in real time based on a plurality of digital images obtained by the RGB camera, (b) generate in real time a depth image via stereo vision and correlate one or more pixels of the depth image to 3D coordinates of the metallic scrap material in real time, and (c) determine a volume of the metallic scrap material in real time based on at least a portion of the 3D coordinates of the metallic scrap material. The system may also include a scrap classifier module in operative communication with the sensor fusion module and comprising a machine learning model. The machine learning model, for example, may be configured to (a) identify one or more different classes or types of the metallic scrap material in real time from a group of known metallic scrap materials (e.g., known classes or types of metallic scrap material) based on at least a portion of a first RGB image received from the sensor fusion unit in real time, (b) assign a density in real time to the metallic scrap material, and (c) determine the scrap feed rate in real time of the metallic scrap material being transported by the conveyor based on the volume of the metallic scrap material, the assigned first density, and the speed of the metallic scrap material in a second computer processor.

In yet another aspect, certain embodiments according to the invention provide an EAF system comprising an EAF including a furnace body defining an interior portion and a set of electrodes extending into the interior portion. The system may also include a conveyor including a first portion distal to the EAF for receiving a metallic scrap material (e.g., fresh feed for the EAF that may be loaded on the conveyor via a railcar or a crane), a second portion proximate to the EAF for charging the metallic scrap material into the interior portion of the EAF, and a third portion located between the first portion and the second portion, wherein the conveyor transports the metallic scrap material from the first portion, across the third portion, across the second portion, and into the interior portion of the EAF. The system may further comprise a sensor fusion module mounted above a section of the third portion of the conveyer. The sensor fusion module may include two monochrome cameras configured to provide stereo vision, a RGB camera, an infrared spectrum projector, and a first computer processor in operative communication with the two monochrome cameras, the RGB camera, and the infrared spectrum projector. In accordance with certain embodiments of the invention, the first computer processor may be configured to (a) determine the speed of the metallic scrap material in real time based on a plurality of digital images obtained by the RGB camera, (b) generate in real time a depth image via stereo vision and correlate one or more pixels of the depth image to 3D coordinates of the metallic scrap material in real time, and (c) determine a volume of the metallic scrap material in real time based on at least a portion of the 3D coordinates of the metallic scrap material. The system, in accordance with certain embodiments of the invention, may comprise a scrap classifier module in operative communication with the sensor fusion module. The scrap classifier module may comprise a machine learning model configured to (a) identify one or more different classes of the metallic scrap material in real time from a group of known metallic scrap materials (e.g., known classes or types of metallic scrap material) based on at least a portion of a first RGB image received from the sensor fusion unit in real time, (b) assign a density in real time to the metallic scrap material, and (c) determine the scrap feed rate in real time of the metallic scrap material being transported by the conveyor based on the volume of the metallic scrap material, the assigned first density, and the speed of the metallic scrap material in a second computer processor.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a continuously charged EAF system including an EAF with a conveyor that may provide a continuous or semi-continuous feed of metallic scrap material into the EAF for conversion into molten steel in accordance with certain embodiments of the invention;

FIG. 2 illustrates a schematic of a continuously charged EAF system including three separate 3D cameras mounted above different locations along the length of a conveyor in accordance with certain embodiments of the invention;

FIG. 3 is an image of a sensor fusion module mounted above a conveyor in accordance with certain embodiments of the invention;

FIG. 4 illustrates an example 3D camera in accordance with certain embodiments of the invention;

FIG. 5 illustrates a schematic of the speed measuring algorithm in accordance with certain embodiments of the invention;

FIG. 6 shows an image of metallic scrap material having speed vectors superimposed on the digital image;

FIG. 7 shows a depth image generated by stereo vision and a corresponding RGB digital image;

FIG. 8 illustrates a 3D composite image formed by merging a depth image and a RGB image in a computer processor in accordance with certain embodiments of the invention;

FIG. 9 illustrates a schematic of a system for operating an EAF system in accordance with certain embodiments of the invention.

FIG. 10 shows a correlation between a scrap speed calculated using a system in accordance with certain embodiments of the invention with a conveyor motor speed set point;

FIG. 11 shows the scrap mix of a system in accordance with certain embodiments of the invention for a complete month; and

FIG. 12 shows how different scrap types mass were accumulated during conveyor movement while an EAF was connected to a system in accordance with certain embodiments of the invention.

### DETAILED DESCRIPTION

Embodiments of the invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise. As used herein, the term “and/or” includes any and all combinations of one or more of the associated listed items.

Embodiments of the present invention relate generally to methods and systems that measure and/or determine the feed rate (unit mass/unit time) of metallic scrap material, for example in real time, being charged to an EAF via a conveyor (or other transportation device). The feed rate of the metallic scrap material, as determined in accordance with certain methods and systems described and disclosed herein, may be integrated with existing programmable logic controls associated with operation of the EAF to provide an accurate tap weight (e.g., weight of molten steel exiting the EAF) estimation and an optimized energy usage (e.g., electrical current consumed by the electrodes of the EAF). In accordance with certain embodiments of the invention, the methods and systems may determine a real time speed of the metallic scrap material being transported by the conveyor, in which the speed of the metallic scrap material is not necessary the same as the conveyor speed since components or pieces of the metallic scrap material may roll-around, shift, bridge-up and become stuck at a particular spot along the length of the conveyor, or otherwise move independent of the speed of the conveyor. In this regard, the determination of the speed of the actual metallic scrap material as compared to simply assuming that it is the same as the conveyor speed provides a significant advantage in determining the feed rate of the metallic scrap material in real time. In accordance with certain embodiments of the invention, the methods and systems may also determine the volume of the metallic scrap material in real time, such as by using stereo vision to generate a depth image (e.g., by comparing relative pixel locations between two digital image taken from two vantage points, three-dimensional information can be extracted by examining the relative positions of objects or pixels in in the two digital images) from which the volume of the metallic scrap material may be determined in a computer processor. The methods and systems, for example, may also comprise obtaining a RGB digital images of the metallic scrap material and processing the RGB through a machine learning model running a model, which may have been previously trained and validated by a machine learning operation, configured to identify and/or classify the nature of the particular metallic scrap material. That is, the metallic scrap material being transported down the conveyer and into the EAF may include a plurality of different types or classes of metallic scrap material (e.g., different chemical compositions, different geometries, etc.). Table 1, for example, illustrates a non-exhaustive summary of some common classes of metallic scrap materials along with their respective chemical compositions, bulk density, and form.

TABLE 1

| Known Metallic Scrap Material | Average Composition / wt-% | Bulk Density / kg m⁻³ | Form^{a} | Cost /tonne |
|---|---|---|---|---|
| No₁ Heavy | 0.025 %C, 0.017 %Si, 0.025 %P, 0.033 %S, 0.2 %Cr, 0.15 %Ni, 0.03 %Mo +Fe bal. | 0.85 | CS | S160 |
| No₂ Heavy | 0.03 %C, 0.022 %Si, 0.028 %P, 0.035 %S, 0.026 %Cr, 0.18 %Ni, 0.03 %Mo +Fe bal. | 0.75 | CS | S140 |
| Internal Low Alloyed | 0.17 %C, 0.04 %Si, 0.31 %Mn, 0.013 %P, 0.0014 %S, 0.26 %Cr, 0.4 %Ni, 0.001 %Nb, 0.015 %Ti, 0.005 %V, 0.14 %Mo +Fe Bal. | 3.0 | CS | S240┊ |
| Plate and Structural | 0.05 %C, 0.25 %Si, 1.0 %Mn, 0.025 %P, 0.025 %S 0.15 %Cr, 0.05 %Mo, 0.15 Ni, 0.22 %Sn | 2.0 | CS | S290 |
| Internal Stainless Steel | 0.015 %C, 0.33 %Si, 1.64 %Mn, 0.014 %P, 0.002 %S, 18.32 %Cr, 8.08 %Ni, 0.01 %Nb, 0.004 %Ti, 0.01 %V, 1.3 %Mo, 0.16 +Fe bal. | 3.0 | CS | S330 |
| No₁ Bundles | 0.027 %C, 0.012 %Si, 0.12 %Mn, 0.01 %P, 0.006 %S, 0.032 %Cr, 0.02 %Ni, 0.001 %Ti + Fe bal. | 1.2 | FS | S180 |
| No₂ Bundles | 0.04 %C, 0.016 %Si, 0.12%Mn, 0.014 %P 0.008 %S, 0.04 %Cr, 0.03 %Ni, 0.0014 %Ti +Fe bal. | 1.1 | FS | S170 |
| Direct Reduced Iron (DRI) | 0.04 %C, 0.1 %P, 0.01 %S, 0.02 %Ti, 0.03 %Nb, 0.02 % +Fe bal. | 1.65 | FS | S220 |
| Shredded | 0.03 %C, 0.015 %Si, 0.02 %P, 0.03 %S, 0.12 %Cr, 0.1 %Ni, 0.02 %Mo +Fe bal. | 1.5 | VFS | S200 |
| No₁ Busheling | 0.03 %C, 0.01 %Si, 0.02 %P, 0.02 %S, 0.08 %Cr, 0.06 %Ni, 0.01 %Mo +Fe bal. | 1.5 | VFS | S210 |

* CS = Coarse Scrap, FS = Fine Scrap, VFS = Very fine Scrap

The machine learning model, for example, may identify the particular class or classes of metallic scrap material based on at least a portion of the RGB digital image in real time. For example, a continuous stream or nearly continuous stream of consecutive or nearly consecutive RGB digital images (e.g., frames) may be processed in real time by the machine learning model to identify when a first portion of the metallic scrap material comprising a first type or class of metallic scrap material has passed and a second portion of the metallic scrap material comprising a second type or class of metallic scrap material is following behind the first portion of the metallic scrap material. Based on the identification of the type or class of metallic scrap material, a scrap density may be assigned to each component or piece of the metallic scrap material being transported down the conveyor and into the EAF. In accordance with certain embodiments of the invention, respective assigned scrap densities along with respective speed values of the metallic scrap material, and respective volume values of the metallic scrap material may be utilized in real time to determine the real time feed rate (unit mass/unit time) of metallic scrap material in a computer processor.

In accordance with certain embodiments of the invention, the methods and systems described and disclosed herein may provide one or more alarms or warnings in real time. For example, the machine learning model may further be configured to identify when undesirable and/or dangerous materials (e.g., materials that are undesirable in the EAF during operation thereof), such as oil or containers that are or may be housing undesirable liquids (e.g., such as one or more oils, based on a RGB digital image. In this regard, the identification of the undesirable and/or dangerous materials may be provided to a computer processer that is configured to trigger and alarm or warning to operators that an undesirable and/or dangerous material is present within the metallic scrap material, such that the operators have an opportunity to remove the undesirable and/or dangerous material prior to being undesirably being charged into the EAF. Additionally or alternatively, the methods and systems may include a computer processor configured to trigger an alarm or warning upon identification of a piece of the metallic scrap material and/or a pile of the metallic scrap material as having a volume above a size threshold and/or an orientation extending outside of a predetermined working zone, in which such identification may be based on the volume determination and/or depth image. Additionally or alternatively, the methods and systems may include a computer processor configured trigger an alarm or warning when a piece of the metallic scrap material is stuck in a particular location of the conveyer, such as being stuck inside a tunnel portion of the conveyer. For example, a portion of the conveyor adjacent and/or proximate an EAF inlet for the metallic scrap material may be covered by a tunnel in which waste heat (e.g., waste gases and/or steam) from the EAF is channeled to pre-heat the metallic scrap material prior to being charged into the EAF. Identification of a stuck piece of the metallic scrap material, for example, may be identified by speed determination of the metallic scrap material.

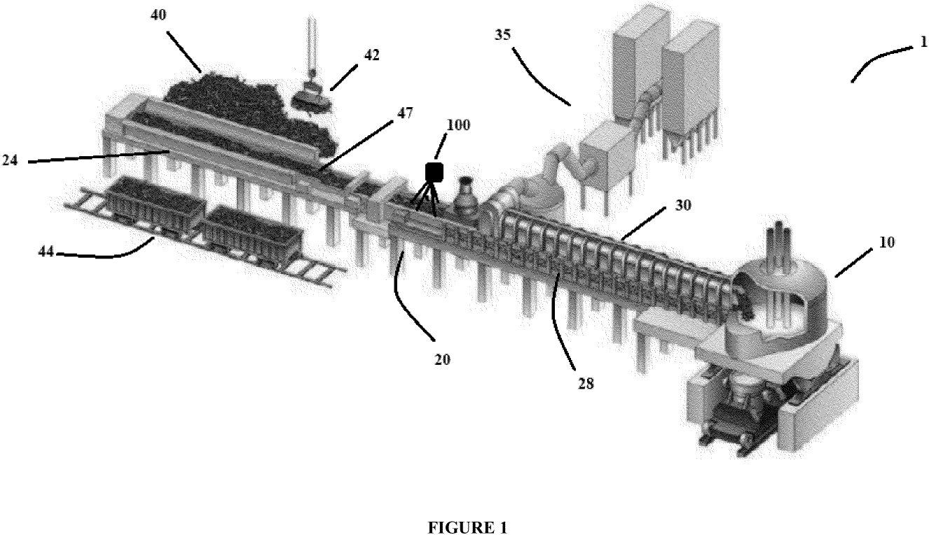

FIG. 1 illustrates a continuously charged EAF system 1 including an EAF 10 with a conveyor 20 that may provide a continuous or semi-continuous feed of metallic scrap material 47 into the EAF for conversion into molten steel. The conveyor may include a distal end 24 with respect to the EAF 10 and a proximate end 28 with respect to the EAF. At least a portion of the proximate end 28 may be covered by a tunnel 30 though with waste heat (e.g., waste gases and/or steam) exiting the EAF 10 may be channeled through to pre-heat the metallic scrap material prior to being charged into the EAF. The EAF system 1 may include an exhaust gas treatment operation 35 that is operatively connected to the tunnel-portion of the proximate end 28 of the conveyor 20. The distal end 24 of the conveyor 20 may be or include a charging section in which metallic scrap material from a storage location 40 or from rail cars 44 may be deposited via, for example, a magnetized crane element 42. The EAF system illustrated by FIG. 1 also includes a sensor fusion module 100 mounted over a portion of the conveyor that is continuously or semi-continuously transporting the metallic scrap material 47 towards the EAF 10. The sensor fusion module 100 may include a three-dimensional (3D) or depth camera and optionally an associated computer processor. The 3D or depth camera, for example, may include two (2) stereo vision monochrome cameras, a red-green-blue (RGB) camera, and an infrared spectrum projector. The 3D or depth camera may also include an inertial measurement unit (IMU) including a gyroscope and an accelerometer, which may assist in offsetting an undesirably vibration of the camera during use. One example 3D or depth camera includes Intel° RealSense™ Depth Camera D435. The 3D or depth camera, for instance, is configured to obtain digital images of the metallic scrap material 47 as it travels down the conveyor 20 towards the EAF 10.

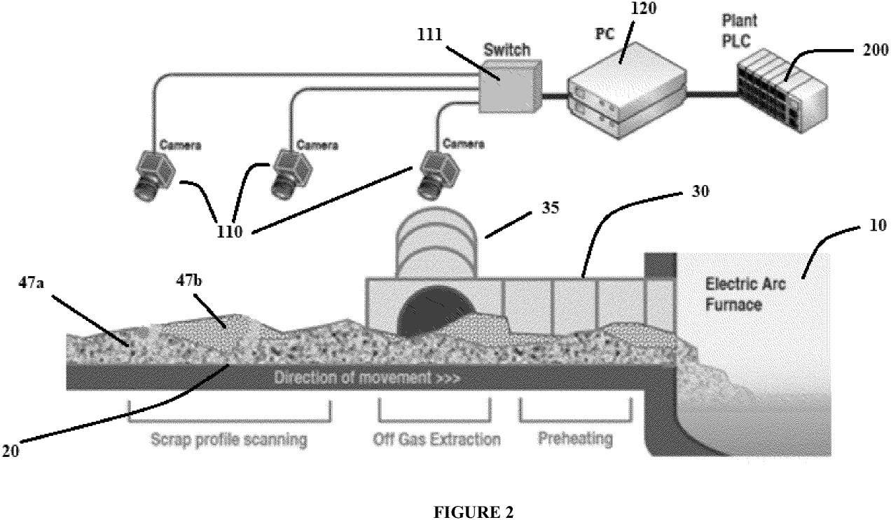

Although FIG. 1 generically illustrates a single location in which a 3D camera may be mounted above the conveyer, certain embodiment of the invention may include a plurality of 3D cameras mounted above and along a portion of the conveyor. FIG. 2, for example, illustrates an example embodiment in which a first type or class 47a of the metallic scrap material and a second (and different) type or class 47b of the metallic scrap material is conveyed towards the EAF 10 via conveyor 20, in which the sensor fusion unit includes three separate 3D cameras 110 mounted above different locations along the length of the conveyor 20. Any one of the three 3D cameras by be selected for use via a switch 110, such that digital images from the selected 3D camera transmits digital images to the computer processor 120 for the determination of the speed and volume of the metallic scrap material underneath the selected camera 110. As shown in FIG. 2, the computer processor 120 may be operatively connected (e.g., directly wired or wirelessly connected) to a separate programmable logic control 200 that may be associated with monitoring and/or controlling the operation of the EAF (e.g., positioning of the electrodes, controlling electrical current to the electrodes, etc.). As discussed throughout, the methods and systems according to certain embodiments of the invention may identify and classify the first type or class 47a and the second type or class 47b of the metallic scrap material via a machine learning model based on at least a portion of an RGB digital image taken by the 3D camera 110 in use. Operation of the machine learning model may be conducted on the computer processor 120 or the programmable logic controller 200.

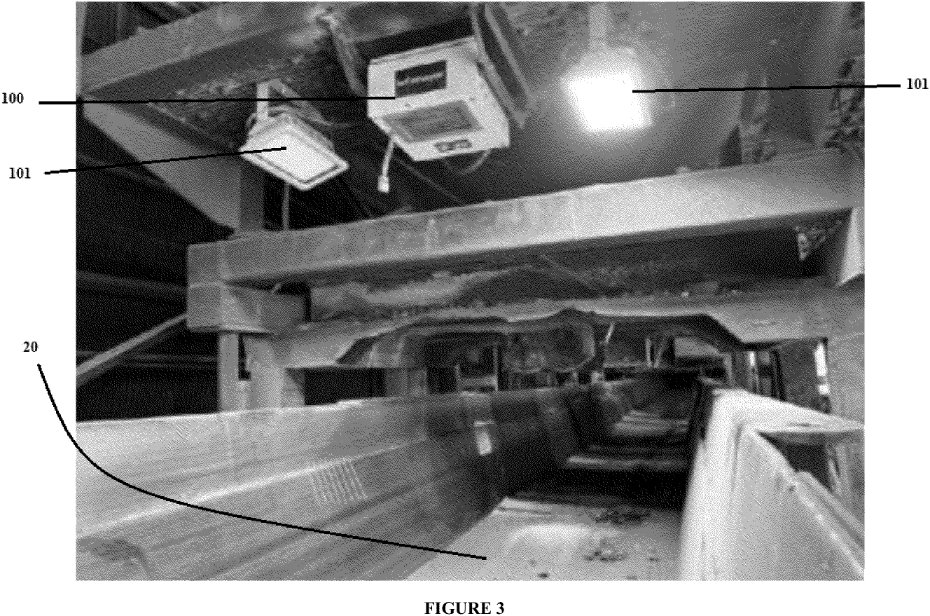

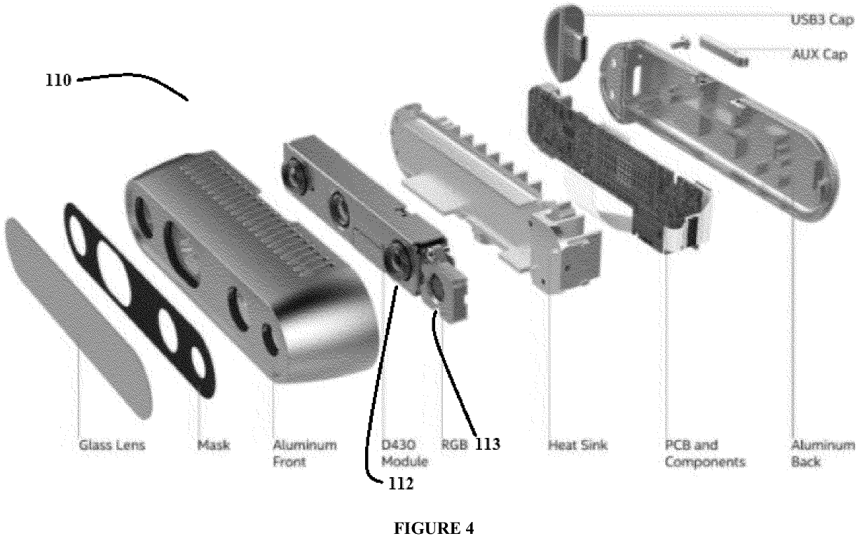

FIG. 3 illustrates a sensor fusion unit 100 mounted above the conveyor 20. As shown in FIG. 3, one or more controllable lighting sources 101 mounted proximate to the fusion sensor module 100 and configured to provide a fixed lighting intensity in real time. The fixed lighting intensity during operation may be helpful in the classification of the metallic scrap material as the machine learning model may include one or more convolution layers that consider and/or weigh color scale(s) at one or more locations of the metallic scrap material. In this regard, the consistent or fixed lighting intensity reduces any potential errors associated with the quality of the RGB digital images used in identifying and/or classifying the metallic scrap material. FIG. 4 illustrates an example 3D camera 110, which may be mounted within the sensor fusion module 100. The 3D camera may include two stereo vision monochrome cameras 112 and one RGB camera 113 housed within a common casing.

In one aspect, certain embodiments of the invention comprise a method of determining a scrap feed rate, such as in real time, of an EAF having a conveyer transporting metallic scrap material into the EAF. The method may include the following steps: (i) obtaining a first plurality of RGB digital images of a first portion of the metallic scrap material being transported by the conveyer; (ii) determining a first speed of the first portion of the metallic scrap material in a computer processor by comparing a first frame and a second frame of the plurality of RGB digital images of the first portion of the metallic scrap material being transported by the conveyer; (iii) generating a first depth image via camera stereo vision of the first portion of the metallic scrap material in the computer processor, wherein one or more pixels of the first depth image are correlated to 3D coordinates (e.g., x,y,z, coordinates) of the first portion of the metallic scrap material in the computer processor; (iv) determining a first volume of the first portion of the metallic scrap material in the computer processer based on at least a portion of the 3D coordinates of the first portion of the metallic scrap material; (v) identifying a first classification of the first portion of metallic scrap material from a group of known metallic scrap materials based on at least a portion of a first RGB image via a machine learning model in the computer processor, and assigning a first density to the first portion of scrap material; and (vi) determining the scrap feed rate associated with the first portion of the metallic scrap material being transported by the conveyor based on (a) the first volume of the first portion of the metallic scrap material, (b) the assigned first density, and (c) the first speed of the first portion of the metallic scrap material.

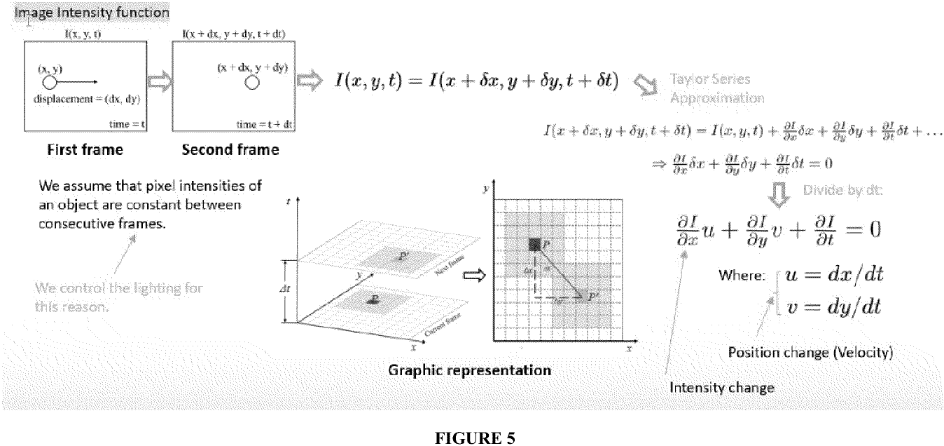

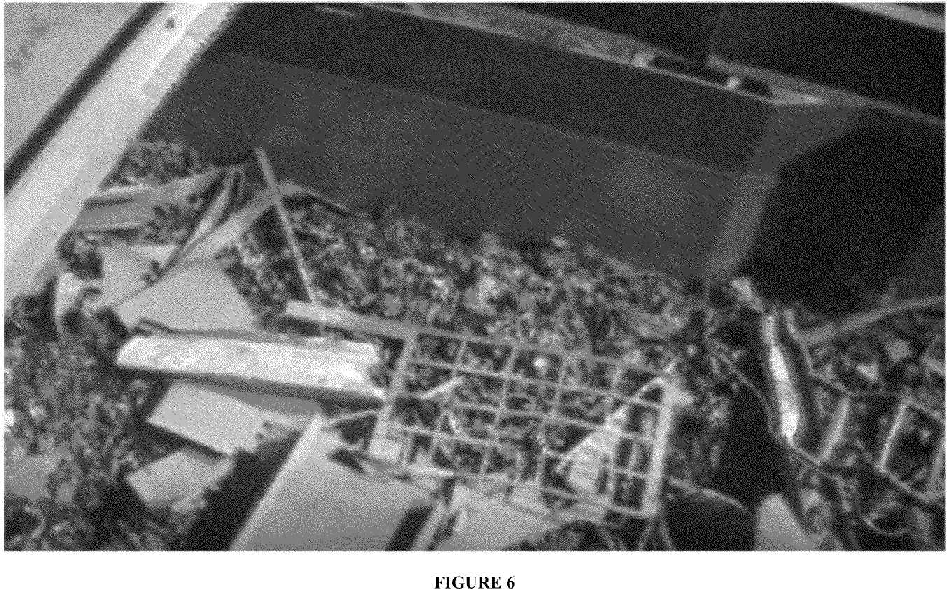

In accordance with certain embodiments of the invention, the first frame and the second frame may be consecutive frames of the plurality of RGB digital images. In this regard, the relative movement of one or more selected points (e.g., pixels or clusters of adjacent pixels) of the first portion of the metallic scrap material from the first frame to the second frame are compared in the computer processor to determine the first speed of the first portion of the metallic scrap material. The computer processor, for example, may be configured to perform a variety of algorithms to determine the speed of the first portion of the metallic scrap material. In accordance with certain embodiment of the invention, the computer processor may be configure to execute the Horn-Schunck method based on the first frame and the second frame to determine the first speed of the first portion of the metallic scrap material. In this regard, the Horn-Schunck method was found to be particularly suitable and computationally efficient as this algorithm assumes smoothness in the flow over the whole image. This assumption in the algorithm minimizes distortions in flow and prefers solutions which show more smoothness. Moreover, the pixel intensities of the RGB digital images of the first portion of the metallic scrap material are constant between consecutive frames. In accordance with certain embodiments of the invention, therefore, the use of controllable lighting sources mounted proximate to the fusion sensor module and configured to provide a fixed lighting intensity in real time may be beneficial. FIG. 5, for example, illustrates a schematic of the speed measuring algorithm (i.e., Horn-Schunck method) in accordance with certain embodiments of the invention, which the first speed of the first portion of the metallic scrap material is defined by a two-dimensional (2D) vector field generated in the computer processor as illustrated by FIG. 6 (i.e., image of metallic scrap material having speed vectors superimposed on the digital image).

As noted above, in accordance with certain embodiments of the invention the computer processor may be configured to identify and/or trigger an alarm when a first component of the first portion of the metallic scrap material is falling or rolling on the conveyer based on the 2D vector field. For example, the computer processor may be configured to trigger an alarm or warning when a piece of the metallic scrap material is stuck in a particular location of the conveyer, such as being stuck inside a tunnel portion of the conveyer.

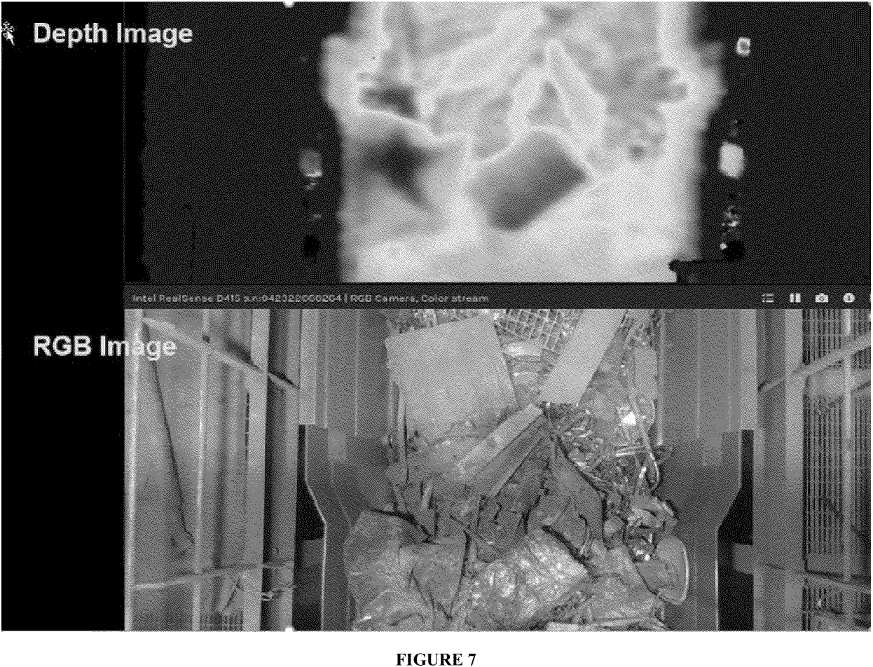

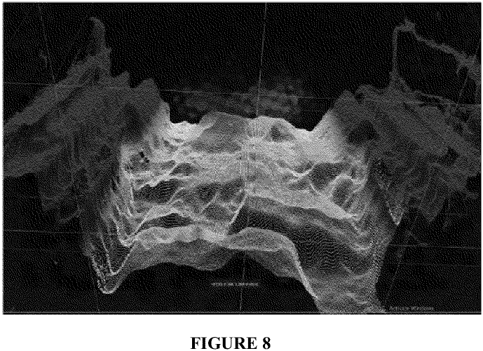

In accordance with certain embodiments of the invention, the method of determining a scrap feed rate, such as in real time, of an EAF having a conveyer transporting metallic scrap material into the EAF may further comprise a step of merging the first depth image and the first RGB image to generate a first 3D composite image of the first portion of the metallic scrap material in the computer processor and displaying the first 3D composite image onto a user display. FIG. 7, for instance, shows a depth image (e.g., red regions are closer to the camera while blue regions are farther away from the camera) generated by the stereo vision on the top of the figure and a corresponding RGB digital image on the bottom of the image. These images can be merged by the computer processor to form a 3D composite image as illustrated in FIG. 8. The 3D composite image may be displayed on a user display to provide an easily visual illustration of the metallic scrap material in real time. Additionally or alternatively, the method may comprise a step of conducting a volume-calibration operation comprising mapping a plurality pixels associated with a plurality of known locations of a calibration implement (e.g., an inanimate object of known dimensions placed onto the conveyor while the conveyor is not being operated) to a 3D coordinate system (e.g., x,y,z), and generating a volume-calculating model in the computer processor based on the mapped pixels, in which the volume-calculating model is configured to determine the volume of the metallic scrap material in the computer processer based on at least a portion of the 3D coordinates of the metallic scrap material imaged.

In accordance with certain embodiments of the invention, the first RGB image may be transmitted to the machine learning model for convergence on a solution, such as identification and/or classification of the metallic scrap material imaged (e.g., the first portion of metallic scrap material) from a group of known metallic scrap materials based on at least a portion of a first RGB image via a machine learning model in the computer processor. After the machine learning model converges onto a solution for the identification of the metallic scrap material imaged (e.g., NO₂ Heavy), a computer processor may assign, for example, a first density to the first portion of scrap material (e.g., NO₂ Heavy has a density of 0.75 kg/m³) and determine the scrap feed rate associated with the first portion of the metallic scrap material being transported by the conveyor based on (a) the first volume of the first portion of the metallic scrap material, (b) the assigned first density, and (c) the first speed of the first portion of the metallic scrap material.

In accordance with certain embodiments of the invention, the machine learning model as disclosed and described herein may comprise one or more types of machine learning including, for example, neural networks (e.g., convolutional neural networks, recurrent neural networks, deep learning neural networks, natural language processing, etc.), transformers, support vector machines (SVM), and clusters (e.g., clustered machine learning). In this regard, for instance, the use of the term “machine learning model” throughout the present disclosure may include (i) a single type of machine learning model in accordance with certain embodiments of the invention (ii) a plurality of different types of machine learning models in accordance with certain other embodiments of the invention. For example only, a first type of machine learning model (e.g., a neural network) may be employed for the identification and classification of one or more types or classifications of metallic scrap material while a second type of machine learning model may be employed for the identification and/or classification of undesirable materials or potentially undesirable materials (e.g., oils or other liquids that are not desirable within the EAF, closed containers that may contain oils or other liquids that are not desirable within the EAF, etc.) intermixed with the metallic scrap material intended to be charged into the EAF. The first type of machine learning model, for example, may comprise a deep learning solution with a plurality of convolution layers and/or a plurality of pooling layers, and at least one fully-connected layer configured for the identification and/or classification of one or more types or classes of metallic scrap material. In this regard, for example, at least one of the convolution layers may capture the scrap type with a maximum score, which is chosen as the classification output for the input scrap image. In accordance with certain embodiments of the invention, a first convolution layer may consider and/or weigh identified straight edges, arcuate edges, colors, and/or color gradients across a surface. In accordance with certain embodiments of the invention, different layers may have different node layouts in which each node may have a respective weight. The respective weights may be calculated during a training phase and a model output may be customized for the different customer scrap types utilized in the EAF.

In accordance with certain embodiments, a scrap classification model was developed using machine learning technology. For example, an initial model may be selected for training, such as by backpropagation which works to feed classified data into the model and then measures the model’s performance. The error rate is measured using a loss function. In this regard, for example, backpropagation works by using gradient descent to measure the rate of change of the loss function with respect to the weighting of each connection, and the gradient descent step is used to make sure the error rate for each connection is reduced as close to zero as possible to assure that network will converge on a solution. In accordance with certain embodiments of the invention, an initial algorithm or model configured for general image identification may be trained by selecting one or more of the following: selecting the percentage of images used for training and for validation (e.g., 70% for training and 30% for validation); applying different preprocess to the input images; setting training and validation thresholds; defining iteration per epoch; selecting the gradient threshold method; choosing the learning rate; and verifying the confusion matrix. Once the trained model satisfies all of the user specifications the model may be exported to a computer processor for use in image identification and/or classification in accordance with certain embodiments of the invention. For example, the algorithm or model may be exported as an Open Neural Network Exchange (ONNX) model. Open Neural Network Exchange (ONNX) is an open format to represent artificial intelligence models that is widely supported and can be found in many frameworks, tools, and hardware. In accordance with certain embodiments, the algorithm or model may be re-trained if an unacceptable number of non-solutions are reached during operation of certain methods as described and disclosed herein.

As noted above and generally illustrated in FIG. 2, the metallic scrap material being transported by the conveyor may include a plurality of different types or classes of metallic scrap materials provided separate from one another or intermixed. In this regard, certain embodiments in accordance with the invention may comprise the following: (i) obtaining a plurality of second RGB digital images of a second portion of the metallic scrap material being transported by the conveyer, wherein the second portion of metallic scrap material is different (e.g., different type or class) than the first portion of metallic scrap material and the first portion of metallic scrap material is located closer to the EAF than the second portion of metallic scrap material; (ii) determining a second speed of the second portion of the metallic scrap material in the computer processor by comparing a first frame and a second frame of the second plurality of RGB digital images of the second portion of the metallic scrap material being transported by the conveyer; (iii) generating a second depth image via camera stereo vision of the second portion of the metallic scrap material in the computer processor, wherein one or more pixels of the second depth image are correlated to 3D coordinates of the second portion of the metallic scrap material in the computer processor; (iv) determining a second volume of the second portion of the metallic scrap material in the computer processer based on at least a portion of the 3D coordinates of the second portion of the metallic scrap material; (v) identifying a second classification of the second portion of metallic scrap material from the group of known metallic scrap materials based on at least a portion of a second RGB image via the machine learning model in the computer processor, and assigning a second density to the second portion of scrap material, and wherein the second classification is different than the first classification; and (vi) determining the scrap feed rate associated with the second portion of the metallic scrap material being transported by the conveyor based on (a) the second volume of the second portion of the metallic scrap material, (b) the assigned second density, and (c) the second speed of the second portion of the metallic scrap material; and wherein the scrap feed rate associated with the second portion of the metallic scrap material is different than the scrap feed rate associated with the second portion of the metallic scrap material. In this regard, the method may comprise determining the scrap feed rate of the metallic scrap material being transported by the conveyer in real time (e.g., the scrap feed rate may vary in real time based on the type or class of the metallic scrap materials and/or their respective volumes).

In another aspect, certain embodiments according to the invention provide a method of operating an EAF. The method may comprise determining a real time scrap feed rate of metallic scrap material being transported into the EAF via a conveyor in real time, such as described and disclosed herein. The method may also comprise comparing the real time scrap feed rate with an operating state (e.g., electric current to the electrodes, etc.) of the EAF in a computer processor, such as programmable logic controller configured for controlling the operation of the furnace conditions, electrical current to the electrodes, taping times, etc.. Additionally, the method may comprise a step of modifying a conveyor speed of the conveyor transporting the metallic scrap material into the EAF, modifying an electric current flow to electrodes in the EAF, or both, such as in real time. The step of modifying the a conveyor speed of the conveyor transporting the metallic scrap material into the EAF, modifying an electric current flow to electrodes in the EAF, or both may be executed by a programmable logic controller configured for controlling the operation of the furnace conditions. In accordance with certain embodiments of the invention, the conveyor speed may be decreased in response to an increase in the real time scrap feed rate and/or the electric current flow may be increased in response to an increase in the real time scrap feed rate. Additionally or alternatively, the conveyor speed may be increased in response to a decrease in the real time scrap feed rate and/or the electric current flow may be decreased in response to a decrease in the real time scrap feed rate.

In accordance with certain embodiments of the invention, the computer processor may be configured to identify and/or trigger a second alarm when a piece of the metallic scrap material and/or a pile of the metallic scrap material is identified as having a volume above a size threshold and/or an orientation extending outside of a predetermined working zone. In this regard, the size threshold may be based on a volume or size that may undesirably strike the electrodes in the EAF during operation. The second alarm, for instance, may enable an operator to raise the electrodes at least partially upward to provide more room for the larger piece of metallic scrap to enter into the EAF without damaging the electrodes. Additionally or alternatively, the machine learning model in the computer processor is configured to identify undesirable materials intermixed with the metallic scrap material and trigger a third alarm and/or stop the conveyer.

In another aspect, certain embodiments according to the invention provide a system for determining a scrap feed rate of an EAF having a conveyer transporting metallic scrap material into the EAF. The system may comprise a sensor fusion module including two monochrome cameras configured to provide stereo vision, a RGB camera, an infrared spectrum projector, and a first computer processor in operative communication with the two monochrome cameras, the RGB camera, and the infrared spectrum projector. The first computer processor, for example, may be configured to (a) determine the speed of the metallic scrap material in real time based on a plurality of digital images obtained by the RGB camera, (b) generate in real time a depth image via stereo vision and correlate one or more pixels of the depth image to 3D coordinates of the metallic scrap material in real time, and (c) determine a volume of the metallic scrap material in real time based on at least a portion of the 3D coordinates of the metallic scrap material. The system may also include a scrap classifier module in operative communication with the sensor fusion module and comprising a machine learning model. The machine learning model, for example, may be configured to (a) identify one or more different classes or types of the metallic scrap material in real time from a group of known metallic scrap materials (e.g., known classes or types of metallic scrap material) based on at least a portion of a first RGB image received from the sensor fusion unit in real time, (b) assign a density in real time to the metallic scrap material, and (c) determine the scrap feed rate in real time of the metallic scrap material being transported by the conveyor based on the volume of the metallic scrap material, the assigned first density, and the speed of the metallic scrap material in a second computer processor. In accordance with certain embodiments of the invention, the system includes one or more controllable lighting sources mounted proximate to the fusion sensor module and configured to provide a fixed lighting intensity in real time as noted previously.

In yet another aspect, certain embodiments according to the invention provide an EAF system comprising an EAF including a furnace body defining an interior portion and a set of electrodes extending into the interior portion. The system may also include a conveyor including a first portion distal to the EAF for receiving a metallic scrap material (e.g., fresh feed for the EAF that may be loaded on the conveyor via a railcar or a crane), a second portion proximate to the EAF for charging the metallic scrap material into the interior portion of the EAF, and a third portion located between the first portion and the second portion, wherein the conveyor transports the metallic scrap material from the first portion, across the third portion, across the second portion, and into the interior portion of the EAF. The system may further comprise a sensor fusion module mounted above a section of the third portion of the conveyer. The sensor fusion module may include two monochrome cameras configured to provide stereo vision, a RGB camera, an infrared spectrum projector, and a first computer processor in operative communication with the two monochrome cameras, the RGB camera, and the infrared spectrum projector. In accordance with certain embodiments of the invention, the first computer processor may be configured to (a) determine the speed of the metallic scrap material in real time based on a plurality of digital images obtained by the RGB camera, (b) generate in real time a depth image via stereo vision and correlate one or more pixels of the depth image to 3D coordinates of the metallic scrap material in real time, and (c) determine a volume of the metallic scrap material in real time based on at least a portion of the 3D coordinates of the metallic scrap material. The system, in accordance with certain embodiments of the invention, may comprise a scrap classifier module in operative communication with the sensor fusion module. The scrap classifier module may comprise a machine learning model configured to (a) identify one or more different classes of the metallic scrap material in real time from a group of known metallic scrap materials (e.g., known classes or types of metallic scrap material) based on at least a portion of a first RGB image received from the sensor fusion unit in real time, (b) assign a density in real time to the metallic scrap material, and (c) determine the scrap feed rate in real time of the metallic scrap material being transported by the conveyor based on the volume of the metallic scrap material, the assigned first density, and the speed of the metallic scrap material in a second computer processor. In accordance with certain embodiments of the invention, the system includes one or more controllable lighting sources mounted proximate to the fusion sensor module and configured to provide a fixed lighting intensity in real time as noted previously.

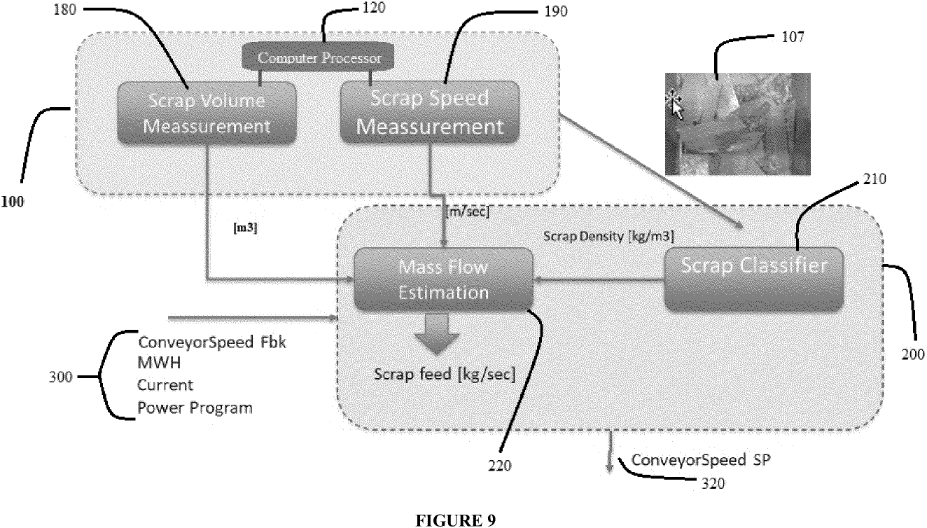

FIG. 9 illustrates a schematic of a system for operating an EAF system in accordance with certain embodiments of the invention that includes a sensor fusion unit 100 including a computer program 120 in operative communication with a metallic scrap volume measurement module 180 and a metallic scrap speed measurement module 190. The sensor fusion 100 delivers the real time speed value of the imaged metallic scrap material and the real time speed value of the imaged metallic scrap material to a programmable logic controller 200 (or other computer processer) associated with controlling the operation of the EAF. The sensor fusion unit 100 also sends an RGB digital image 107 of the metallic scrap material to a scrap classifier module 210 for identification of the type or class of the metallic scrap material via a machine learning model and assign a density to the metallic scrap material. The assigned density, the determined speed and the determined volume of the metallic scrap material may be input to a mass flow estimation module that outputs the real time metallic scrap feed rate. The programmable logic controller may also receive a variety of feedback data 300 from various features of the EAF system. The programmable logic control may compare the real time metallic scrap feed rate with the feedback data 300, and in response to this comparison define or generate a new set point for the conveyor speed to adjust the real time metallic scrap feed rate to the EAF.

### WORKING EXAMPLES

The present disclosure is further illustrated by the following examples, which in no way should be construed as being limiting. That is, the specific features described in the following examples are merely illustrative and not limiting.

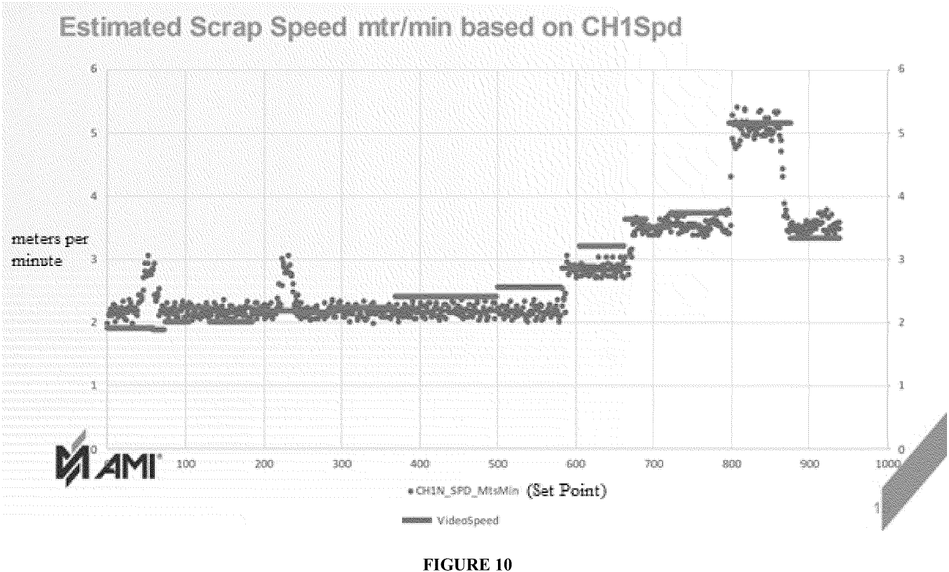

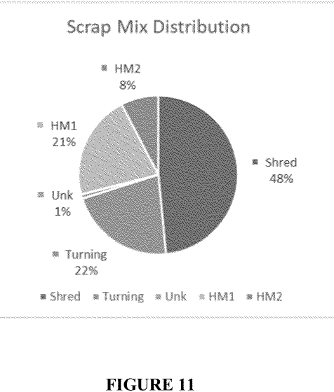

A system in accordance with certain embodiment of the invention was implemented in a steel shop with a Consteel EAF. In this particular steel shop, the conveyor was charged in layers. As such, two sensor fusion modules were installed above the conveyor. One sensor fusion module was mounted at the shredded entrance and a second sensor fusion module was installed just before the re-heating furnace. FIG. 10 shows the correlation between the scrap speed calculated using the system in accordance with certain embodiments of the invention and the conveyor motor speed set point. The Scrap speed shows a 0.87 correlation with the conveyor speed, which reflects the actual inertia of the big scrap pieces vibrating at the conveyor pacing. The steel shop had an alternative scrap estimation systems, based on crane position tracking and magnet load cells. However, this system presented an important delay which made the incoming scrap data inaccurate and in most of the cases not usable. During the commissioning of the system in accordance with certain embodiments of the invention, the scrap tracking means was switched from the crane-based system to the system in accordance with certain embodiments of the invention since it was found to be strikingly more reliable. Having two sensor fusion modules on hand, the material tracking systems were implemented to indicate for the steel shop the exact time a specific scrap (e.g., metallic scrap material) was falling into the EAF. The scrap classification was done using an images database of more than 10.000 images acquired by the first sensor fusion module and the second sensor fusion module, and all the images were preprocessed with different filters. More than 20 deep learning models were evaluated, the best performing model having an accuracy over 95% was selected. During the training, only 70% of the data set was used and the remaining 30% was only used as validation. In this regard, the scrap types of the first data set were labeled manually by a process engineer and later the machine learning model labeled the images automatically. The initial data set contained images of shredder, turning, heavy metal 1, heavy metal 2, mill return, busheling, bundles, plate, and pig iron. Whenever the classification model score was below 50, the image was stored in a separate location for later model retraining. The retraining process was only executed once. Once the scrap was classified, the density assigned to that scrap type was selected. Having the density and knowing both the volume and the speed of the scrap being charged in the EAF in real time, the actual EAF feed rate was estimated with high accuracy. FIG. 11 shows the scrap mix of the system for a complete month that was estimated only by the automatic scrap classification system in accordance with certain embodiments of the invention, showing an accuracy of 99% with the actual plant scrap mix. In this regard, only 1% of the images were classified as unknow, and the rest were the exact mix the steel shop had on that period.

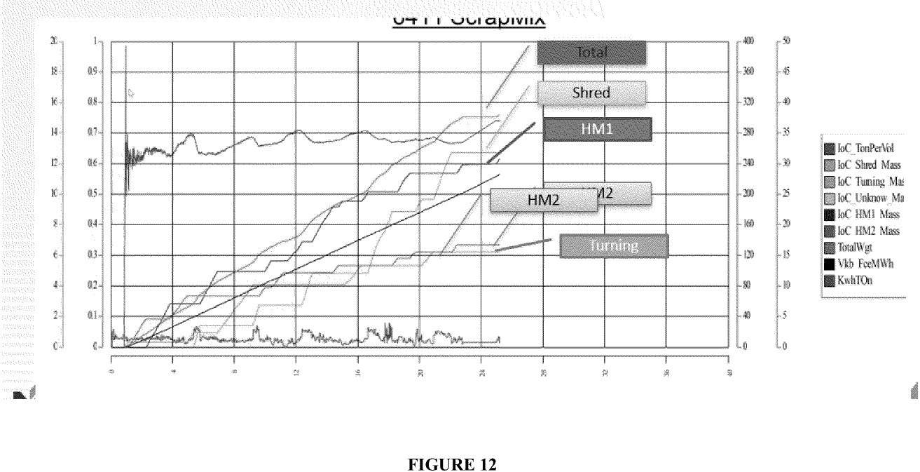

FIG. 12 shows how the different scrap types mass were accumulated during the conveyor movement while the EAF was connected to a system in accordance with certain embodiments of the invention, in which the heat total weight was calculated as 40 tons. The calculated total weight of 40 tons matched the tapping weight of that heat.

These and other modifications and variations to embodiments of the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A method of determining a scrap feed rate of an electric arc furnace (EAF) having a conveyer transporting metallic scrap material into the EAF, comprising:
(i) obtaining a first plurality of red-green-blue (RGB) digital images of a first portion of the metallic scrap material being transported by the conveyer;
(ii) determining a first speed of the first portion of the metallic scrap material in a computer processor by comparing a first frame and a second frame of the plurality of RGB digital images of the first portion of the metallic scrap material being transported by the conveyer;
(iii) generating a first depth image via camera stereo vision of the first portion of the metallic scrap material in the computer processor, wherein one or more pixels of the first depth image are correlated to 3D coordinates of the first portion of the metallic scrap material in the computer processor;
(iv) determining a first volume of the first portion of the metallic scrap material in the computer processer based on at least a portion of the 3D coordinates of the first portion of the metallic scrap material;
(v) identifying a first classification of the first portion of metallic scrap material from a group of known metallic scrap materials based on at least a portion of a first RGB image via a machine learning model in the computer processor, and assigning a first density to the first portion of scrap material; and
(vi) determining the scrap feed rate associated with the first portion of the metallic scrap material being transported by the conveyor based on (a) the first volume of the first portion of the metallic scrap material, (b) the assigned first density, and (c) the first speed of the first portion of the metallic scrap material.

2. The method of claim 1, wherein the first frame and the second frame are consecutive frames of the plurality of RGB digital images, and wherein a relative movement of one or more selected points of the first portion of the metallic scrap material from the first frame to the second frame are compared in the computer processor to determine the first speed of the first portion of the metallic scrap material.

3. The method of claim 1, wherein the computer processor is configured to perform the Horn-Schunck method based on the first frame and the second frame to determine the first speed of the first portion of the metallic scrap material.

4. The method of claim 1, wherein the first speed of the first portion of the metallic scrap material is defined by a two-dimensional (2D) vector field generated in the computer processor.

5. The method of claim 4, wherein the computer processor is configured to identify and/or trigger an alarm when a first component of the first portion of the metallic scrap material is falling or rolling on the conveyer based on the 2D vector field.

6. The method of claim 1, further comprising a step of conducting a volume-calibration operation comprising mapping a plurality of pixels associated with a plurality of known locations of a calibration implement placed on the conveyor to a 3D coordinate system, and generating a volume-calculating model in the computer processor based on the mapped pixels, and wherein the volume-calculating model is configured to determine the volume of the first portion of metallic scrap material in the computer processer based on at least a portion of the 3D coordinates of the first portion of the metallic scrap material.

7. The method of claim 1, further comprising a step of merging the first depth image and the first RGB image to generate a first 3D composite image of the first portion of the metallic scrap material in the computer processor and displaying the first 3D composite image onto a user display.

8. The method of claim 1, wherein the machine learning model includes a plurality of convolution layers and/or a plurality of pooling layers, and at least one fully-connected layer, wherein at least one of the convolution layers captures the scrap type with a maximum score, which is chosen as the classification output for the input scrap image.

9. The method of claim 1, further comprising:
(i) obtaining a plurality of second RGB digital images of a second portion of the metallic scrap material being transported by the conveyer, wherein the second portion of metallic scrap material is different than the first portion of metallic scrap material and the first portion of metallic scrap material is located closer to the EAF than the second portion of metallic scrap material;
(ii) determining a second speed of the second portion of the metallic scrap material in the computer processor by comparing a first frame and a second frame of the second plurality of RGB digital images of the second portion of the metallic scrap material being transported by the conveyer;
(iii) generating a second depth image via camera stereo vision of the second portion of the metallic scrap material in the computer processor, wherein one or more pixels of the second depth image are correlated to 3D coordinates of the second portion of the metallic scrap material in the computer processor;
(iv) determining a second volume of the second portion of the metallic scrap material in the computer processer based on at least a portion of the 3D coordinates of the second portion of the metallic scrap material;
(v) identifying a second classification of the second portion of metallic scrap material from the group of known metallic scrap materials based on at least a portion of a second RGB image via the machine learning model in the computer processor, and assigning a second density to the second portion of scrap material, and wherein the second classification is different than the first classification; and
(vi) determining the scrap feed rate associated with the second portion of the metallic scrap material being transported by the conveyor based on (a) the second volume of the second portion of the metallic scrap material, (b) the assigned second density, and (c) the second speed of the second portion of the metallic scrap material; and wherein the scrap feed rate associated with the second portion of the metallic scrap material is different than the scrap feed rate associated with the second portion of the metallic scrap material.

10. The method of claim 1, wherein the scrap feed rate of the metallic scrap material being transported by the conveyer is provided in real time.

11. The method of claim 1, wherein the machine learning model executes an algorithm developed by machine learning.

12. A method of operating an electric arc furnace (EAF), comprising:
(i) determining a real time scrap feed rate of metallic scrap material being transported into the EAF via a conveyor in real time in accordance with claim 1;
(ii) comparing the real time scrap feed rate with on operating state of the EAF in a computer processor;
(iii) modifying a conveyor speed of the conveyor transporting the metallic scrap material into the EAF, modifying an electric current flow to electrodes in the EAF, or both.

13. The method of claim 12, wherein the conveyor speed is decreased in response to an increase in the real time scrap feed rate and/or the electric current flow is increased in response to an increase in the real time scrap feed rate.

14. The method of claim 12, wherein the conveyor speed is increased in response to a decrease in the real time scrap feed rate and/or the electric current flow is decreased in response to a decrease in the real time scrap feed rate.

15. The method of claim 11, wherein the computer processor is configured to identify and/or trigger a second alarm when a piece of the metallic scrap material and/or a pile of the metallic scrap material is identified as having a volume above a size threshold and/or an orientation extending outside of a predetermined working zone.

16. The method of claim 11, wherein the machine learning model in the computer processor is configured to identify undesirable materials intermixed with the metallic scrap material and trigger a third alarm and/or stop the conveyer.

17. A system for determining a scrap feed rate of an electric arc furnace (EAF) having a conveyer transporting metallic scrap material into the EAF, comprising:
(i) a sensor fusion module including two monochrome cameras configured to provide stereo vision, a RGB camera, an infrared spectrum projector, and a first computer processor in operative communication with the two monochrome cameras, the RGB camera, and the infrared spectrum projector; wherein the first computer processor is configured to (a) determine the speed of the metallic scrap material in real time based on a plurality of digital images obtained by the RGB camera, (b) generate in real time a depth image via stereo and correlate one or more pixels of the depth image to 3D coordinates of the metallic scrap material in real time, and (c) determine a volume of the metallic scrap material in real time based on at least a portion of the 3D coordinates of the metallic scrap material;
(ii) a scrap classifier module in operative communication with the sensor fusion module and comprising a machine learning model configured to (a) identify one or more different classes of the metallic scrap material in real time from a group of known metallic scrap materials based on at least a portion of a first RGB image received from the sensor fusion unit in real time, (b) assign a density in real time to the metallic scrap material, and (c) determine the scrap feed rate in real time of the metallic scrap material being transported by the conveyor based on the volume of the metallic scrap material, the assigned first density, and the speed of the metallic scrap material in a second computer processor.

18. The system of claim 17, further comprising one or more controllable lighting sources mounted proximate to the fusion sensor module and configured to provide a fixed lighting intensity in real time.

19. An electric arc furnace (EAF) system, comprising:
(i) an EAF including a furnace body defining an interior portion and a set of electrodes extending into the interior portion;
(ii) a conveyor including a first portion distal to the EAF for receiving a metallic scrap material, a second portion proximate to the EAF for charging the metallic scrap material into the interior portion of the EAF, and a third portion located between the first portion and the second portion, wherein the conveyor transports the metallic scrap material from the first portion, across the third portion, across the second portion, and into the interior portion of the EAF;
(iii) a sensor fusion module mounted above a section of the third portion of the conveyer, the sensor fusion module including two monochrome cameras configured to provide stereo vision, a RGB camera, an infrared spectrum projector, and a first computer processor in operative communication with the two monochrome cameras, the RGB camera, and the infrared spectrum projector; wherein the first computer processor is configured to (a) determine the speed of the metallic scrap material in real time based on a plurality of digital images obtained by the RGB camera, (b) generate in real time a depth image via stereo and correlate one or more pixels of the depth image to 3D coordinates of the metallic scrap material in real time, and (c) determine a volume of the metallic scrap material in real time based on at least a portion of the 3D coordinates of the metallic scrap material;
(ii) a scrap classifier module in operative communication with the sensor fusion module and comprising a machine learning model configured to (a) identify one or more different classes of the metallic scrap material in real time from a group of known metallic scrap materials based on at least a portion of a first RGB image received from the sensor fusion unit in real time, (b) assign a density in real time to the metallic scrap material, and (c) determine the scrap feed rate in real time of the metallic scrap material being transported by the conveyor based on the volume of the metallic scrap material, the assigned first density, and the speed of the metallic scrap material in a second computer processor.

20. The system of claim 19, further comprising one or more controllable lighting sources mounted proximate to the fusion sensor module and configured to provide a fixed lighting intensity in real time onto the section of the third portion of the conveyer.
